(19) United States
(12) Patent Application Publication
(10) Pub. No.: US 2005/0206433 A1
(43) Pub. Date: Sep. 22, 2005

(54) Apparatus for transferring various direct current voltage levels to digital output voltage levels

(75) Inventor: Chih-Min Liu, Taipei (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: VIA TECHNOLOGIES, INC., Taipei (TW)

(21) Appl. No.: 11/010,391

(22) Filed: Dec. 14, 2004

(30) Foreign Application Priority Data
Mar. 19, 2004 (TW) 093107535

(51) Int. Cl. H02J 3/36

(52) U.S. Cl. 327/333

(57) ABSTRACT

The present invention provides a means for transferring direct current voltage levels to digital output voltage levels that includes a first voltage selection block, an inverter, a second voltage selection block, and a voltage transfer block. One end of the voltage selection block is connected to an analog voltage, and the other end is connected to one end of the inverter. The input of the inverter is connected to an input signal; besides, one of its ends is connected to the first voltage selection block and another end is connected to one end of the second voltage selection block. Moreover, one end of the second voltage selection block is connected to the ground. Furthermore, the output is used to receive the inverter output signal and output a digital output signal. The transferring circuit device is utilized to modulate different voltage transfer ranges and transfer direct current voltage levels to digital output levels; moreover, it can efficiently reduce the chip area and the power of the device when it is working.

### BACKGROUND OF THE INVENTION

1. Field of the Invention

The present invention generally relates to a means of transferring direct current voltage levels to digital output voltage levels, and more particularly to a means of modulating different voltage transfer ranges and transferring various direct current voltage levels to digital output voltage levels.

2. Description of the Prior Art

In order to discriminate high level from low level in the chip design field of the CD-ROM drive, it is required to transfer various direct current voltage levels (for instance, 0.5V, 1.5V and 2.5V) of input chips in accordance with the specification of products. For instance, transferring the direct current voltage levels of 0.5V and 1.5V to digital low-level output, and transferring the direct current voltage level of 2.5V to digital high-level output. Referring to FIG. 1, it depicts one conventional technique that uses a comparator for transferring process, the reference voltage V_{R} (which is between 1.5V and 2.5V) is inputted to the negative input of the comparator, and the direct current input voltage V_{D} is inputted to the positive input of the comparator. Since there is a 1.2V supply voltage within the chip, it is therefore that when the direct current input voltage V_{D} is smaller than the reference voltage V_{R} and then the output voltage V_{O} is 0V; otherwise, when the direct current input voltage V_{D} is greater than the reference voltage V_{R} and then the output voltage V_{O} is 1.2V. FIG. 2 is the relation diagram between the direct current input voltage V_{D} and the reference voltage V_{R}. However, since the reference voltage V_{R} keeps in a turn-on situation at any time, thus the above-mentioned technique will produce additional currents and excess power consumption. Besides, the comparator circuit is large-size (compared to the chip area), thus results in reducing of the integration of IC chip.

Referring to FIG. 3, it depicts another conventional technique using a method that changes the voltage level shift for transferring the analog voltage AV_{DD} (for instance, 3.3V) of chips within the CD-ROM drive to the digital voltage DV_{DD} (for instance, 1.2V) and thus achieving the above-mentioned objectives. The sources of the PMOS transistors MP1 and MP2 are respectively connected to the analog voltage AV_{DD} (3.3V) and the digital voltage DV_{DD} (1.2V) of chips within the CD-ROM drive. Further, when the voltage level of the direct current input voltage V_{D} is between 0V and the threshold voltage (for instance, 0.7V) and then the transistor MP1 is turned on and the transistor MN1 is in a turn-off situation. Therefore, the output voltage of the input-stage inverter (which is composed of the transistors MP1, MN1) is AV_{DD} and then serves as the input voltage of the output-stage inverter (which is composed of the transistors MP2 and MN2). At this time, to the transistors MP2 and MN2, the analog voltage AV_{DD} is respectively in a turn-off and turn-on situation; therefore, the output voltage of the output-stage inverter is 0V. Similarly, when the voltage level of the direct current input voltage V_{D} is greater than the threshold voltage (about 0.7V) of the transistor MN1 and then the transistor MP1 is turned off and the transistor MN1 is in a turn-on situation. Therefore, the output voltage of the input-stage inverter is 0V and then serves as the input voltage of the output-stage inverter. In this regard, to the transistors MP2 and MN2, 0V is respectively turn-on and turn-off. Thus, the output voltage of the output-stage inverter is the digital voltage DV_{DD}. FIG. 4 is the relation diagram between the direct current input voltage V_{D} and the output voltage V_{O} by using the method that changes the voltage level shift.

In the conventional technique that changes the voltage level shift, since it uses the analog voltage AV_{DD} and the digital voltage DV_{DD} within chips, thus there is no need to generate a reference voltage by an additional circuit (such as the comparator described above), which results in simplified IC design and reduced chip area. However, the PMOS and NMOS transistors in FIG. 3 can merely distinguish the voltage from being greater than (AV_{DD}-Vₜₚ) and smaller than Vₜₙ, wherein Vₜₚ and Vₜₙ are respectively the threshold voltages of the transistors MP1 and MN1. Accordingly, when the direct current input voltage V_{D} is between Vₜₙ and (AV_{DD}-Vₜₚ) and thus the transistors MP1 and MN1 might both be in a turn-on situation. Furthermore, when the dimensions of the transistors are forced to be adjusted to match with the direct current input voltage, the input-stage PMOS and NMOS transistors will consume much more static-state power.

### SUMMARY OF THE INVENTION

In consideration of the problems which accompany the conventional technique using a method that changes the voltage level shift, the present invention provides a means of modulating different voltage transfer ranges and transferring direct current voltage levels to digital output levels. The characteristic of the present invention is to avoid using comparator for largely decreasing the static-state power consumption and reducing the chip area. Accordingly, one main objective of the present invention is to use voltage selection blocks for generating various voltage transition ranges and thus distinguishing from various direct input signals and transferring them to the corresponding digital signals.

One preferred embodiment of the present invention provides a means for transferring direct current voltage levels to digital output voltage levels that includes a first voltage selection block, an inverter, a second voltage selection block and a voltage transfer block. The first voltage selection block and the second voltage selection block are configured to control the size of the transient area when the input signals are under transition. Therefore, the inverter receives the input signals including a plurality of various levels and there is no input signal positioned in the transient area that affects operation of the inverter. And next, the signal is outputted to the voltage transition block and therefore generates corresponding digital signal for output.

### BRIEF DESCRIPTION OF THE DRAWING

The present invention can be best understood through the following description and accompanying drawings, wherein:

FIG. 1 schematically shows the diagram of a comparator;

FIG. 2 schematically shows the relation diagram between the input and the output voltages of a comparator;

FIG. 3 schematically shows the circuit diagram of the conventional technique using a method that changes the voltage level shift;

FIG. 4 schematically shows the relation diagram between output and input voltage of the circuit according to the conventional technique using a method that changes the voltage level shift;

FIG. 5 schematically shows the block diagram of a means for transferring direct current voltage levels to digital output voltage levels in accordance with one embodiment of the present invention;

FIG. 6 schematically shows the circuit diagram of a means for transferring direct current voltage levels to digital output voltage levels in accordance with one embodiment of the present invention; and

FIG. 7 schematically shows the circuit diagram of a means for transferring direct current voltage levels to digital output voltage levels in accordance with another embodiment of the present invention.

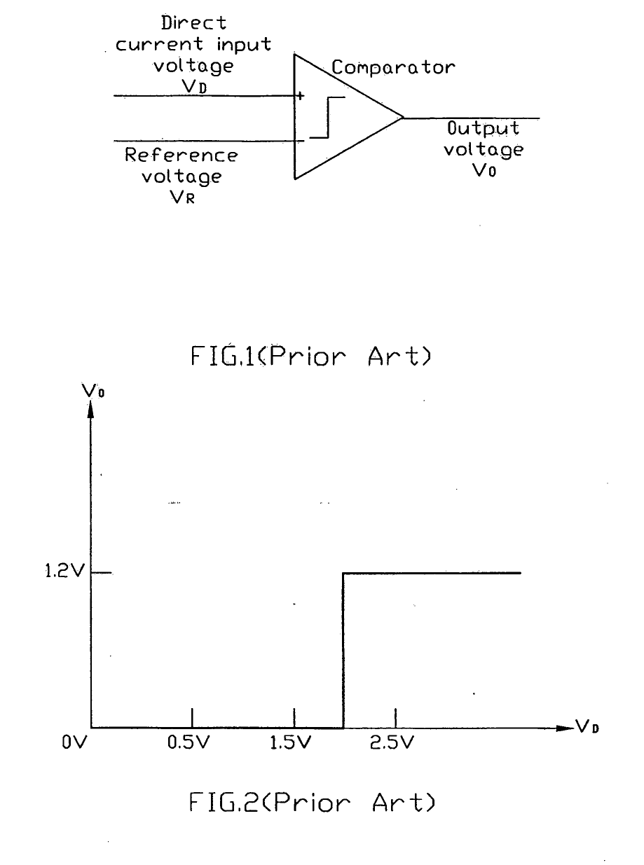

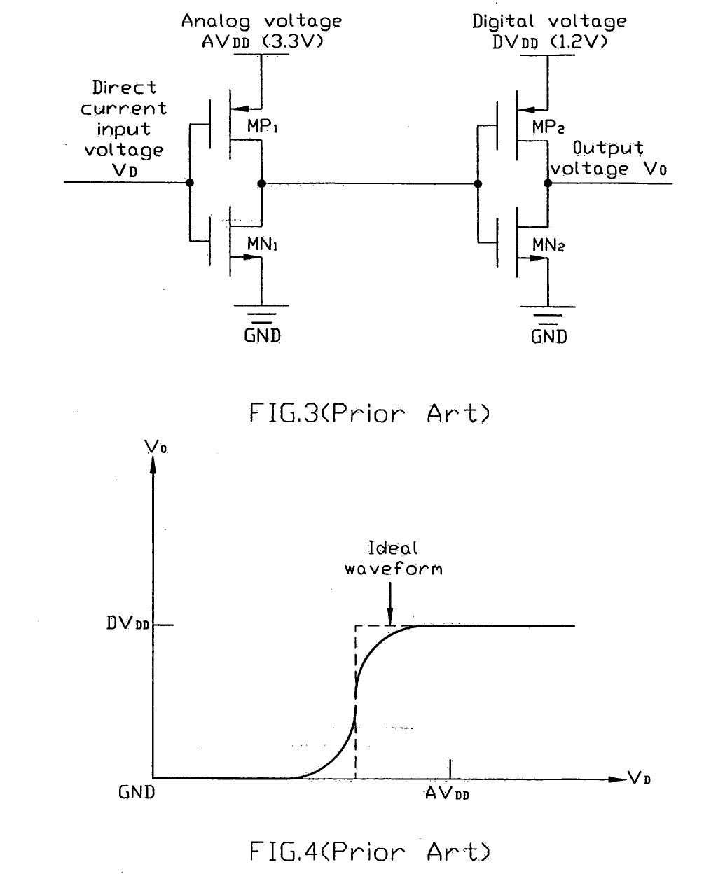

### DESCRIPTION OF THE PREFERRED EMBODIMENT

Some appropriate and preferred embodiments of the present invention will now be described in the following. It should be noted, however, that the embodiment is merely an example and can be variously modified without departing from the range of the present invention.

It is to be understood, however, that the drawings, which are not to scale, are designed for the purpose of illustration and not as a definition of the limits of the invention, for which reference should be made to the appended claims.

Referring to FIG. 5, it depicts a means for transferring various direct current voltage levels to digital output voltage levels in accordance with one embodiment of the present invention. The means 100 for transferring various direct current voltage levels to digital output voltage levels includes a first voltage selection block 110, an inverter 120, a second voltage selection block 130 and a voltage transfer block 140. One end of the first voltage selection block 110 is connected to an analog voltage (AV_{DD}) and another end of the first voltage selection block 110 is connected to one end of the inverter 120. Next, the input of the inverter 120 is connected to the input signal (V_{I}), one end of the inverter 120 is connected to one end of the first voltage selection block 110 and another end of the inverter 120 is connected to one end of the second voltage selection block 130. And next, another end of the second voltage selection block 130 is connected to the ground. One input of the voltage transfer block 140 is connected to the output of the inverter 120, one end of the voltage transfer block 140 is connected to a digital voltage (DV_{DD}) and another end of the voltage transfer block 140 is connected to the ground. It should be appreciated that, in the means 100 according to one embodiment of the present invention, the first and second voltage selection block (110 and 130) are configured to compress the input signal (V_{I}) range which may turn on both PMOS and NMOS (the transient area) into the smallest size. In this regard, it can avoid the positioning of input signal (V_{I}) in the range (transient) and avoid excess power consumption.

According to the means described above, the first voltage selection block 110 is turned on and the second voltage selection block 130 is turned off when the voltage level of the input signal (V_{I}) of the inverter 120 is between 0V and a threshold voltage (the size of the threshold voltage depends on the first and second voltage selection block according to the performance requirement of the applications, and will be discussed further in the following). In this regard, the analog voltage (AV_{DD}) is outputted through the inverter 120 by the first voltage selection block 110 and then serves as the input voltage of the voltage transfer block 140. At this time, the output of the voltage transfer block 140 is a digital signal with low voltage level (for instance, 0V) when the analog voltage (AV_{DD}) is greater than the digital voltage (DV_{DD}) of the voltage transfer block 140. On the other hand, the first voltage selection block 110 is turned off and the second voltage selection block 130 is turned on when the voltage of the input signal (V_{I}) of the inverter 120 is greater than the threshold voltage, and thus the inverter 120 is in a grounded situation. At this time, the output of the voltage transfer block 140 is a digital signal with high voltage level (i.e. the digital voltage DV_{DD}). Therefore, the output of the voltage transfer block 140 in the present invention can be used to transfer and then output a digital signal (V_{O}) in accordance with high voltage level or low voltage level of the output of the inverter 120.

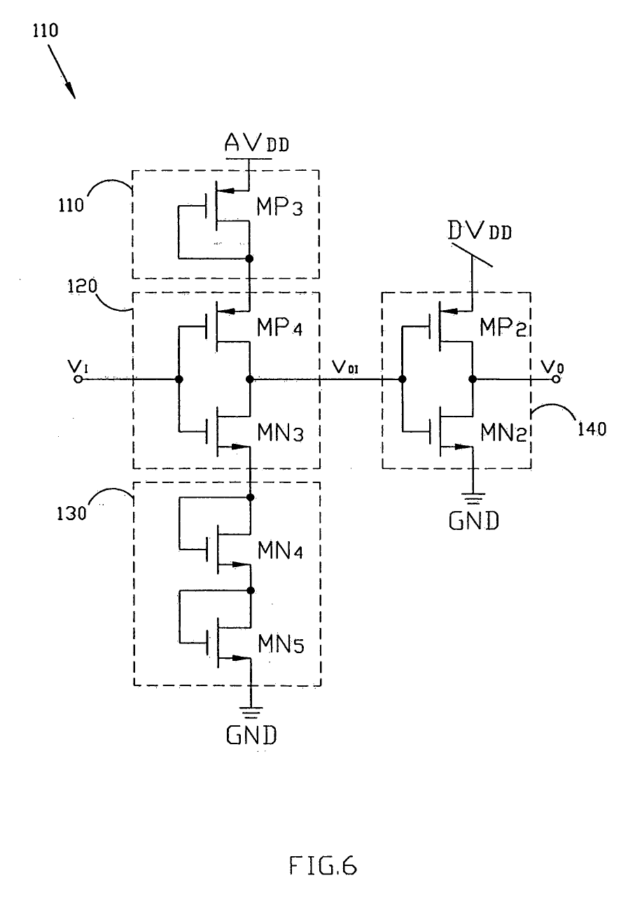

Furthermore, referring to FIG. 6, it schematically shows the circuit diagram of a means for transferring direct current voltage levels to digital output voltage levels in accordance with one embodiment of the present invention. The objective of the means is to make the transition range (or called the transient area) effectively controlled at a certain value (for instance, 2V) when transferring direct current voltage levels to digital output voltage levels. In this regard, the transition range is compressed into the smallest size for avoiding the static-state power consumption. The first voltage selection block 110 is composed of a PMOS transistor MP3; the inverter 120 is composed of a PMOS transistor MP4 and NMOS transistor MN3; the second voltage selection block 130 is composed of two NMOS transistors (MN4 and MN5); and the voltage transfer block 140 is composed of two CMOS transistors (MP2 and MN2).

Continuing to refer to FIG. 6, when the voltage of the input signal (V_{I}) is 0.5V, the digital voltage (DV_{DD}) is 1.2V and the analog voltage (AV_{DD}) is 3.3V, then the transistors MN3, MN4 and MN5 are in a turn-off situation. It is because that the voltage of V_{I} is smaller than the threshold voltage (about 2.1V) of the series-connected transistors MN3, MN4 and MN5; moreover, to the transistors MP3 and MP4, the voltage difference between the AV_{DD} and V_{I} is about 2.6V, which is greater than the threshold voltage (about 1.2V˜1.4V) of the series-connected transistors MP3 and MP4, and thus the transistors MP3 and MP4 after being series-connected are in a turn-on situation. Therefore, the current of the analog voltage (AV_{DD}) flows to the output of the inverter 120 and thus the voltage of AV_{DD} is taken as the input voltage of the voltage transfer block 140. Next, since the transistor MP2 is in a turn-off situation and the transistor MN2 is in a turn-on situation, thus the voltage of the digital output signal V_{O} received by the voltage transfer block 140 is 0V. Similarly, when the voltage of the input signal V_{I} is 1.5V, since the threshold voltage formed by the transistors MN4 and MN5 of the second voltage selection block and another transistor MN3 is 2.1V, thus its operation is similar to the above-mentioned and the voltage of the digital output signal V_{O} received by the voltage transfer block 140 is 0V.

When the voltage of the input signal V_{I} rises to 2.5V, the digital voltage DV_{DD} is 1.2V and the analog voltage AV_{DD} is 3.3V, and since the voltage of V_{I} is greater than the threshold voltage (about 2.1V) of the series-connected transistors MN3, MN4 and MN5, thus the transistors MN3, MN4 and MN5 are in a turn-on situation. However, to the transistors MP3 and MP4, since the voltage difference between the AV_{DD} and V_{I} is 0.8V (i.e. 3.3V−2.5V=0.8V), which is smaller than the threshold voltage (about 1.2V˜1.4V) of the series-connected transistors MP3 and MP4, thus the transistors MP3 and MP4 after being series-connected are in a turn-off situation. Since the transistors MN3, MN4 and MN5 are in a turn-on situation, thus the second voltage selection block is in a grounded situation and the input voltage of the voltage transfer block 140 is 0V. And next, since the transistor MP2 is in a turn-on situation and the transistor MN2 is in a turn-off situation, thus the output signal V_{O} of the voltage transfer block 140 is 1.2V. Similarly, when the voltage of the input signal V_{I} is 3V, the voltage level of the digital output signal V_{O} to the voltage transfer block 140 is 1.2V.

It must be emphasized herein that, the quantity of the components within the first voltage selection block 110 and the second voltage selection block 130 of the present invention can be determined by the voltage of AV_{DD} and V_{I} for transferring the input signal V_{I} with various formats to corresponding digital signals with high-level or low-level voltage. For instance, when AV_{DD} is 4.2V and a digital signal output with high-level transferred from the voltage over 2V is desired, then the first voltage selection block 110 can be composed of two series-connected PMOS transistors. According to the circuit operation described above, when V_{I} is smaller than 2.1V, then the second voltage selection block 130 is in a turn-off situation and the first voltage selection block 110 is in a turn-on situation; it is therefore that the output signal V_{O} of the voltage transfer block 140 is 0V. Similarly, when V_{I} is greater than 2.1V, then the second voltage selection block 130 is in a turn-on situation and the first voltage selection block 110 is in a turn-off situation; it is therefore that the output signal V_{O} of the voltage transfer block 140 is digital signal 1.2V. Accordingly, when AV_{DD}rises, it can choose V_{I} through the quantity of the PMOS transistors within the first voltage selection block 110.

Similarly, when transferring the input signal V_{I} with greater voltage to corresponding digital signals with high-level voltage, it can be achieved by adding the quantity of the NMOS transistors within the second voltage selection block 130. For instance, when AV_{DD} is 4.2V and a digital signal output with high-level transferred from the voltage over 3V is desired, then the second voltage selection block 130 can be composed of three series-connected NMOS transistors. According to the circuit operation described above, when V_{I} is smaller than 2.8V (i.e. the voltage drop formed by 4 NMOS transistors), then the second voltage selection block 130 is in a turn-off situation and the first voltage selection block 110 is in a turn-on situation; it is therefore that the output signal V_{O} of the voltage transfer block 140 is 0V. Similarly, when V_{I} is greater than 2.8V, then the second voltage selection block 130 is in a turn-on situation and the first voltage selection block 110 is in a turn-off situation; it is therefore that the output signal V_{O} of the voltage transfer block 140 is digital signal 1.2V. Accordingly, the present invention can achieve the objective of transferring direct current voltage levels to digital output levels by choosing the quantity and size of MOS transistors (different sizes can have different MOS threshold voltages Vₜₚ, Vₜₙ) within the first and the second voltage selection block in accordance with the varying conditions of the V_{I} and AV_{DD}.

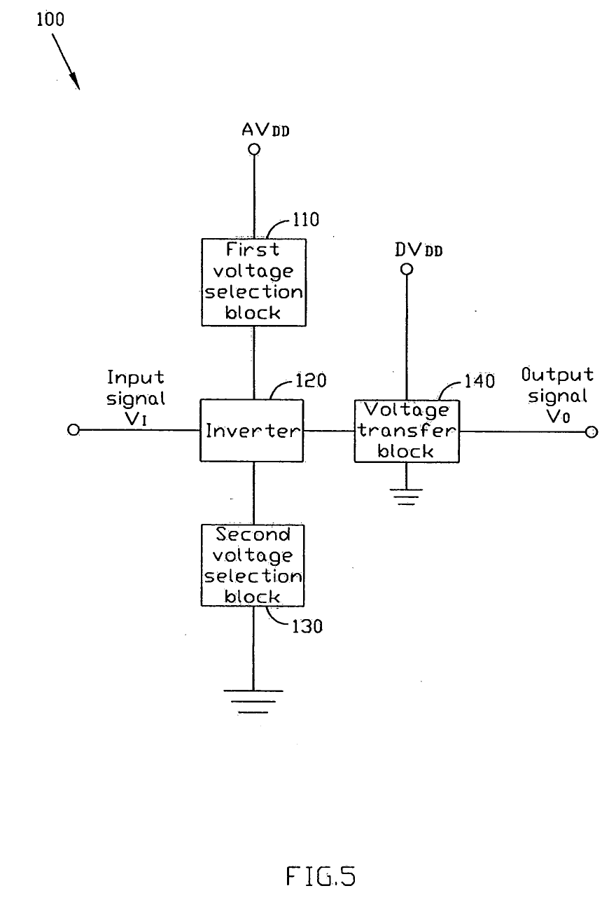

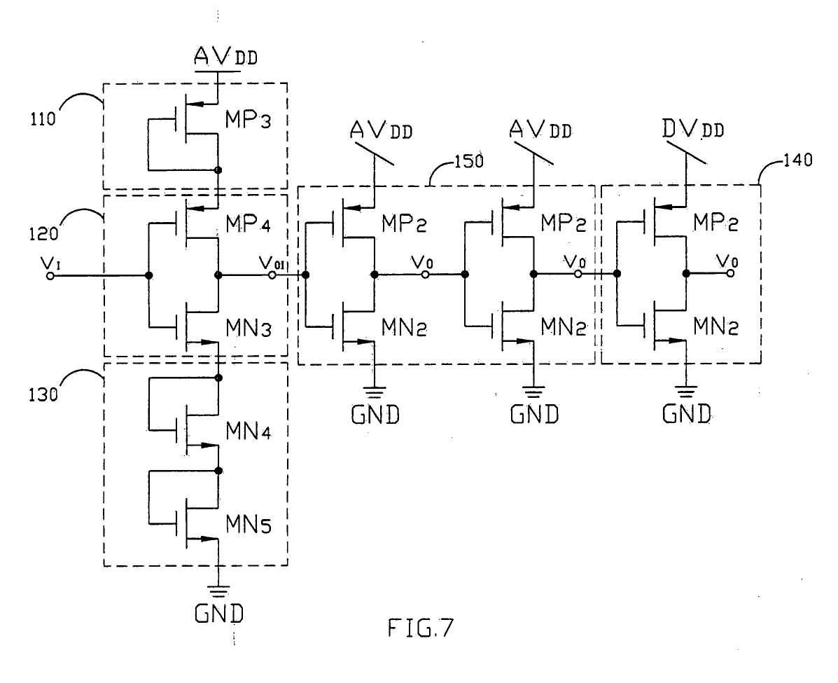

Next, referring to FIG. 4, the output waveform after the transition between analog signals and digital signals includes transition regions of the voltage with non-sharp slope, thus the practical transition point of the input voltage is not easy to know. Therefore, the present invention provides another preferred embodiment for making the voltage transition waveform to be much sharper, which is shown in FIG. 7. The means is configured to add a voltage waveform refit block 150 between the inverter 120 and the voltage transfer block 140, wherein the voltage waveform refit block 150 is composed of series-connected inverters formed by even numbers of CMOS circuits. The input of the voltage waveform refit block 150 is connected to the inverter 120; the output of the voltage waveform refit block 150 is connected to the input of the voltage transfer block 140; one end of the voltage waveform refit block 150 is connected to the analog voltage AV_{DD}; and another end of the voltage waveform refit block 150 is connected to the ground. When the analog voltage AV_{DD} passes through the voltage waveform refit block 150, the output waveform of transferring to the digital signals will become much sharper. Further, if there are more CMOS circuits in the voltage waveform refit block 150, then the output waveform will be nearer to the ideal waveform.

In the embodiments of the present invention, the voltage selection block is composed of a plurality of PMOS and NMOS transistors, thus the means uses internal analog voltages (for instance, 3.3V or 4.2V) and then there is no need to use additional circuits for generating the reference voltage. And next, the means uses the voltage waveform refit block 150 for refitting the output waveform. Finally, the voltage transfer block is used for transferring input signals to corresponding digital signals. The design of the means according to the present invention uses CMOS circuits for an overall arrangement, thus it can avoid using comparators; moreover, it can simplify the chip design and reduce the means dimension compared to the chip area, and thus largely reduce the operation power consumption. Besides, for CMOS circuits, since the analog direct current signal AV_{DD} is high voltage, thus the components that are connected to AV_{DD} must be constructed from high-voltage components.

When the means for transferring direct current voltage levels to digital output voltage levels is embedded in chips of the CD-ROM drive, it can transfer various direct current levels (for instance, 0.5V, 1.5V and 2.5V) of input chips; moreover, it can discriminate high-level from low-level and then output digital signals DV_{DD}.

While this invention has been described with reference to illustrative embodiments, this description does not intend or construe in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A means for transferring direct current voltage levels to digital output voltage levels, comprising:
a first voltage selection block, one end of said first voltage selection block being connected to an analog voltage;
an inverter, an input of said inverter being connected to an input signal and said input signal having a plurality of various levels, and one end of said inverter being connected to said first voltage selection block;
a second voltage selection block, one end of said second voltage selection block being connected to said inverter, and another end of said second voltage being connected to the ground; and
a voltage transfer block, an input of said voltage transfer block being connected to an output of said inverter, one end of said voltage transfer block being connected to a digital voltage, another end of said voltage transfer block being connected to the ground and thus producing a digital signal output;
wherein said first voltage selection block and said second voltage selection block being configured to control size of a transient area of said input signal when signals are transferred, said transient area affecting operation of said inverter.

2. The means according to claim 1, wherein said first voltage selection block is composed of at least one three-terminal device.

3. The means according to claim 2, wherein said at least one three-terminal device is a p-type metal oxide semiconductor field effect transistor (P-MOSFET).

4. The means according to claim 1, wherein said second voltage selection block is composed of at least one three-terminal device.

5. The means according to claim 4, wherein said at least one three-terminal device is an n-type metal oxide semiconductor field effect transistor (N-MOSFET).

6. The means according to claim 2, wherein said at least one three-terminal device is a high-voltage component.

7. The means according to claim 1, wherein said inverter is a high-voltage component.

8. The means according to claim 2, wherein said voltage transfer block is a CMOS circuit structure.

9. The means according to claim 1, further comprising:
a voltage waveform refit block, wherein an input of said voltage waveform refit block being connected to said output of said inverter, one end of said voltage waveform refit block being connected to said analog direct current signal, another end of said voltage waveform refit block being connected to the ground and an output of said voltage waveform refit block being connected to said input of said voltage transfer block.

10. The means according to claim 9, wherein said voltage waveform refit block is composed of even numbers of inverters.

11. The means according to claim 10, wherein said even numbers of inverters are high-voltage components.

12. A means embedded in chips of CD-ROM drive for transferring various direct current voltage levels to digital output voltage levels, comprising:
a first voltage selection block, one end of said first voltage selection block being connected to an analog voltage;
an inverter, an input of said inverter being connected to an input signal and said input signal having different levels, and one end of said inverter being connected to said first voltage selection block;
a second voltage selection block, one end of said second voltage selection block being connected to said inverter, and another end of said second voltage being connected to the ground;
a voltage transfer block, an input of said voltage transfer block being connected to an output of said inverter, one end of said voltage transfer block being connected to a digital voltage, another end of said voltage transfer block being connected to the ground and thus producing a digital signal output; and
a chip system of CD-ROM drive, configured for being connected to said digital signal outputted from said voltage transfer block.

13. The means according to claim 12, wherein said first voltage selection block is composed of at least one three-terminal device.

14. The means according to claim 13, wherein said at least one three-terminal device is a p-type metal oxide semiconductor field effect transistor (P-MOSFET).

15. The means according to claim 12, wherein said second voltage selection block is composed of at least one three-terminal device.

16. The means according to claim 15, wherein said at least one three-terminal device is an n-type metal oxide semiconductor field effect transistor (N-MOSFET).

17. The means according to claim 13, wherein at least one three-terminal device is a high-voltage component.

18. The means according to claim 12, wherein said inverter is a high-voltage component.

19. The means according to claim 12, wherein said voltage transfer block is a CMOS circuit structure.

20. The means according to claim 12, further comprising:
a voltage waveform refit block, wherein an input of said voltage waveform refit block being connected to said output of said inverter, one end of said voltage waveform refit block being connected to said analog direct current signal, another end of said voltage waveform refit block being connected to the ground and an output of said voltage waveform refit block being connected to said input of said voltage transfer block.

21. The means according to claim 20, wherein said voltage waveform refit block is composed of even numbers of inverters.

22. The means according to claim 21, wherein said even numbers of inverters are high-voltage components.
